(19) United States
(12) Patent Application Publication
(10) Pub. No.: US 2010/0309593 A1
(43) Pub. Date: Dec. 9, 2010

(54) SEMICONDUCTOR DEVICE AND ELECTROSTATIC DISCHARGE PROTECTION METHOD FOR THE SEMICONDUCTOR DEVICE

(75) Inventor: Yasuyuki MORISHITA, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/789,944

(22) Filed: May 28, 2010

(30) Foreign Application Priority Data
Jun. 8, 2009 (JP) 2009-137586

(51) Int. Cl. H02H 9/04

(52) U.S. Cl. 361/56

(57) ABSTRACT

For enhancing performance of the electrostatic discharge protection for a semiconductor IC (integrated circuit), the electrostatic discharge protection circuit includes: a power source system for supplying a current to a semiconductor IC in the semiconductor device through a power source potential line and a reference potential line; a primary protection circuit for releasing a surge current to the power source system through a first node connected to a signal terminal when the surge current is generated at the signal terminal; a trigger circuit for generating a trigger signal in response to a surge voltage generated at the power source system; and a secondary protection circuit. The secondary protection circuit releases the surge current to the power source system through a second node connected between the first node and the semiconductor IC in response to the trigger signal, so that the surge voltage can be rapidly suppressed near the semiconductor IC.

### INCORPORATION BY REFERENCE

This patent application is based on Japanese Patent Application No. 2009-137586. The disclosure of the Japanese Patent Application is incorporated herein by reference.

### BACKGROUND OF THE INVENTION

1. Field of the Invention

The present invention relates to a technique for protecting a semiconductor device from electrostatic discharge.

2. Description of Related Art

In recent years, mostly, semiconductor devices have electrostatic discharge protection circuits for protecting internal circuits from an electrostatic discharge (ESD) stress. In particular, since smaller and high speed operation circuits are desired, as a gate insulating-film of a field effect transistor (FET), a thinner insulating-film tends to be adopted. However, there is a problem that the tolerance of a thin gate insulating-film against electrostatic charges is low. Under the circumstances, more advanced protection means for electrostatic discharge is desired.

As a reference example of the electrostatic discharge protection circuit, Japanese Patent No. 3386042 (which is referred to as Patent Document 1) will be described. FIGS. 1A and 1B show an electrostatic discharge protection circuit in a third embodiment of this patent document. An internal circuit R-20 includes a group of signal terminals R-21. When an electrostatic surge is applied to a first signal terminal R-23C in the group of signal terminals R-21, the electrostatic discharge protection circuit is operated for electrostatic discharge protection.

FIG. 1A shows electric current paths in a case where a positive electrostatic surge voltage is applied to the first signal terminal R-23C, where a voltage at a GND terminal R-13 is considered as a reference voltage. The positive electrostatic surge voltage applied to the first signal terminal R-23C causes electrical discharge from the GND terminal R-13 by a first electric current R-I1 and a fifth electric current R-I5. The first electric current R-I1 flows into the GND terminal R-13 through a resistor R-R8, an NMOS R-2, and a GND wiring R-14. The fifth electric current R-I5 flows into the GND terminal R-13 through a diode R-4, a VDD wiring R-12, an NMOS R-3, and the ground wiring R-14.

FIG. 1B shows electric current paths in a case where a negative electrostatic surge voltage is applied to the first signal terminal R-23C, where a voltage at a VDD terminal R-11 is taken as a reference voltage. The negative electrostatic surge voltage applied to the first signal terminal R-23C causes electrical discharge from the VDD terminal R-11 by a second electric current R-I2 and a sixth electric current R-I6. The second electric current R-I2 flows from the VDD terminal R-11 into the first signal terminal R-23C through the VDD wiring R-12, a PMOS R-1, and the resistor R-R8. The sixth electric current R-I6 flows from the VDD terminal R-11 into the first signal terminal R-23C through the VDD wiring R-12, the NMOS R-3, the GND wiring R-14, and a diode R-5.

In this electrostatic discharge protection circuit, a snapback operation using a parasitic bipolar transistor is utilized for electrostatic discharge by the PMOS R-1, the NMOS R-2, and the NMOS R-3. By setting the voltage for starting the snapback operation, timing of starting application of electric current to each element is determined.

### SUMMARY

By the technique illustrated in Patent Document 1, a semiconductor device can be protected from the electrostatic discharge. However, as described above, in recent years, higher electrostatic discharge protection performance is desired for semiconductor devices. The inventor of the present application focused on the fact that the electrostatic discharge protection performance may be limited because of the voltage for starting operation of the parasitic bipolar transistor in the electrostatic discharge protection circuit as illustrated in Patent Document 1 is high.

According to an aspect of the present invention, a semiconductor device includes an electrostatic discharge protection circuit. The electrostatic discharge protection circuit includes: a power source system for supplying a current to a semiconductor integrated circuit included in the semiconductor device through a power source potential line and a reference potential line; a primary protection circuit for releasing a surge current to the power source system through a first node connected to a signal terminal when the surge current is generated at the signal terminal; a trigger circuit for generating a trigger signal in response to a surge voltage generated at the power source system; and a secondary protection circuit for releasing the surge current to the power source system through a second node connected between the first node and the semiconductor integrated circuit in response to the trigger signal.

According to an aspect of a method for protecting a semiconductor device from an electrostatic discharge, The semiconductor device includes a power source system for supplying a current to a semiconductor integrated circuit included in the semiconductor device through a power source potential line and a reference potential line. The method includes: releasing a surge current to the power source system through a first node connected to a signal terminal when the surge current is generated at the signal terminal; generating a trigger signal in response to a surge voltage generated at the power source system; and releasing the surge current to the power source system through a second node connected between the first node and the semiconductor integrated circuit in response to the trigger signal.

According to the present invention, a secondary protection circuit releases a surge electric current in response to a trigger signal for suppressing a surge voltage applied to a region near a semiconductor integrated circuit at an early timing. As a result, a semiconductor device and an electrostatic discharge protection method for the semiconductor device having a high electrostatic discharge protection performance are provided.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1A is a diagram showing electric current paths when a positive electrostatic surge voltage is applied in an electrostatic discharge protection circuit in a reference example;

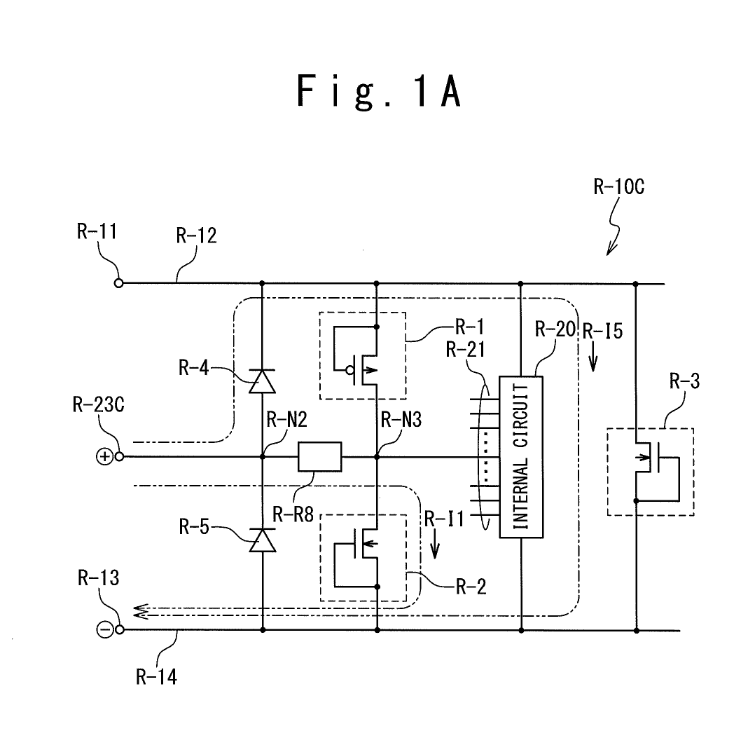

FIG. 1B is a diagram showing electric current paths when a negative electrostatic surge voltage is applied in the electrostatic discharge protection circuit in the reference example; and

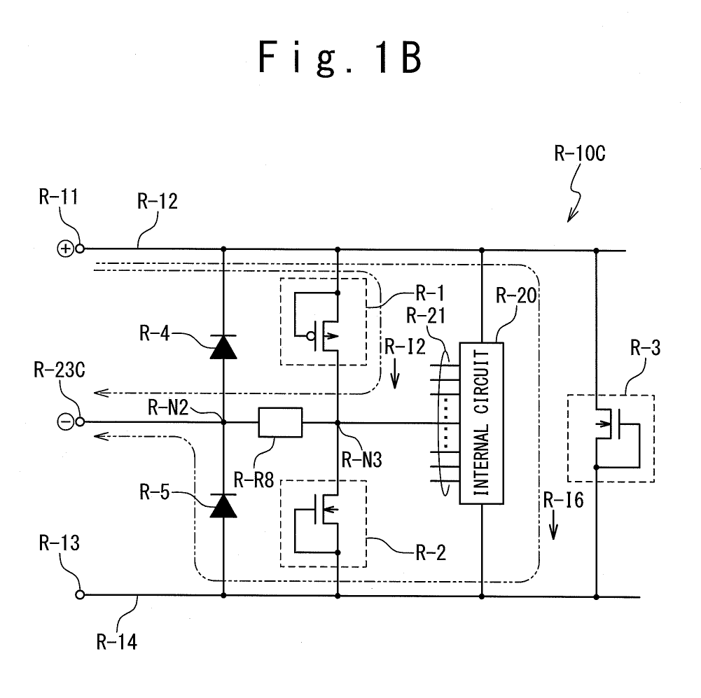

FIG. 2 is a diagram showing a semiconductor device according to an embodiment of the present invention.

### DESCRIPTION OF THE PREFERRED EMBODIMENTS

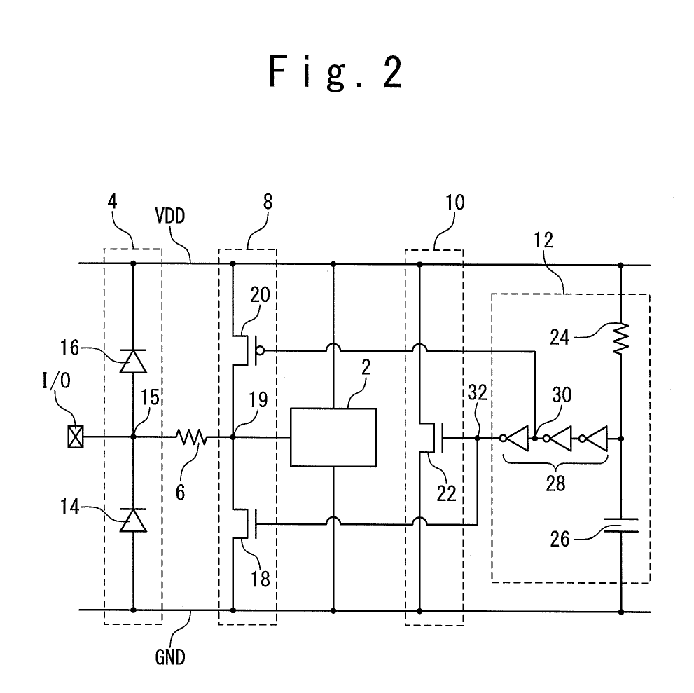

Hereinafter, some exemplary embodiments of the present invention will be described with reference to the drawings. FIG. 2 shows a configuration of a semiconductor device according to an embodiment of the present invention. The semiconductor device has an internal circuit 2 which is a semiconductor integrated circuit. The internal circuit 2 is operated by a power source system including a power source potential supplied from a power source potential line VDD connected to a power source terminal and a reference potential supplied from a ground potential line GND connected to a ground terminal. Further, the internal circuit 2 is connected to an input/output terminal I/O for inputting/outputting signals.

The semiconductor device has an electrostatic discharge protection circuit for protecting the internal circuit 2 from electrostatic discharge. The electrostatic discharge protection circuit includes a trigger circuit 12, a primary protection circuit 4, a resistor element 6, a secondary protection circuit 8, and a power source protection circuit 10.

The main function of the primary protection circuit 4 is to release a surge electric current inputted from the input/output terminal I/O to the power source system. The primary protection circuit 4 has a diode 14 and a diode 16 that are connected in series. The anode of the diode 14 is connected to a ground potential line GND. The cathode of the diode 14 is connected to the anode of the diode 16 through a node 15. The node 15 is connected to the input/output terminal I/O. The cathode of the diode 16 is connected to the power source potential line VDD.

When the primary protection circuit 4 releases an electric current to the power source system, a surge voltage is generated due to the wiring resistance. The main function of the secondary protection circuit 8 is to suppress the surge voltage in the area near the internal circuit 2. The second protection circuit 8 includes a CMOS circuit including an NMOS transistor 18 and a PMOS transistor 20. The source of the NMOS transistor 18 is connected to the ground potential line GND. The drain of the NMOS transistor 18 is connected to the drain of the PMOS transistor 20 through a node 19. The source of the PMOS transistor 20 is connected to the power source potential line VDD.

The node 19 which is an intermediate node of the CMOS circuit is connected to the node 15 which is an intermediate node of the primary protection circuit 4 through a resistor element 6 provided for protection. Further, the node 19 is connected to the internal circuit 2. Therefore, the input/output terminal I/O of the semiconductor device is firstly connected to the primary protection circuit 4, and then, the input/output terminal I/O is connected to the secondary protection circuit 8 provided downstream of the primary protection circuit 4 at a position closer to the internal circuit 2 on the wiring path. Further, the input/output terminal I/O is connected to the internal circuit 2 at a position downstream of the secondary protection circuit 8.

The power source protection circuit 10 includes an NMOS transistor 22. The source of the NMOS transistor 22 is connected to the ground potential line GND, and the drain of the NMOS transistor 22 is connected to the power source potential line VDD.

The trigger circuit 12 includes an RC trigger part including a resistor element 24 and a capacitor element 26 that are connected in series, and a buffer 28. One end of the resistor element 24 is connected to the power source potential line VDD. The other end of the resistor element 24 is connected to one end of the capacitor element 26. The other end of the capacitor element 26 is connected to the ground potential line GND. A connection node between the resistor element 24 and the capacitor element 26 is connected to an input terminal of the buffer 28. The buffer 28 can be composed of at least one inverter element. In the example of FIG. 2, the buffer 28 is made up of three inverter elements that are connected in series.

The buffer 28 includes first and second nodes having potentials inverted to one another, on the front and back sides of an odd number of inverters that are connected in series. In the case of FIG. 2, the first node is the node 32 on the output side of the third inverter from the input side, and the second node is the node 30 on the output side of the second inverter. In this embodiment of the present invention, as described above, a signal from an output node of an even numbered inverter and a signal from an output node of an odd numbered inverter as viewed from the input side are respectively used as trigger signals of the electrostatic discharge protection circuit.

The node 32 is connected to the gate of the NMOS transistor 22 of the power source protection circuit 10. Further, the node 32 is connected to the gate of the NMOS transistor 18 of the secondary protection circuit 8. The node 30 is connected to the gate of the PMOS transistor 20 of the secondary protection circuit 8.

In FIG. 2, the gate of the NMOS transistor 18 of the secondary protection circuit 8 and the gate of the NMOS transistor 22 of the power source protection circuit 10 are connected to the same node 32. However, such connection is not essential. As long as binary signals having a same value are inputted to the gate of the NMOS transistor 18 and the gate of the NMOS transistor 22, the supply of such signals may be performed by other means. However, it should be noted that the common node 32 as shown in FIG. 2 can be utilized advantageously to simplify the circuit.

In the semiconductor device as described above, when a positive electrostatic surge voltage is applied to the input/output terminal I/O where a voltage at the GND terminal is taken as a reference voltage, the surge electric current flows the power source potential line VDD through the diode 16 of the primary protection circuit 4. As a result, the potential at the power source potential line VDD is increased temporarily. The trigger circuit 12 generates a trigger signal transiently for a period determined by the time constant of the RC trigger circuit. The trigger signal is amplified and binarized by the buffer 28, and outputted as a binary trigger signal. At this time, the potential of the node 32 is increased relative to the GND potential, and the potential of the node 30 is decreased relative to the VDD potential.

In response to the trigger signal generated at the node 32, the NMOS transistor 22 of the power source protection circuit 10 is turned on, and electric current flows from the power source potential line VDD to the ground potential line GND through the NMOS transistor 22. Further, in response to the trigger signal generated at the node 32, the NMOS transistor 18 of the secondary protection circuit 8 is turned on. Further, in response to the trigger signal generated at the node 30, the PMOS transistor 20 of the secondary protection circuit 8 is turned on. As a result, by the CMOS of the secondary protection circuit 8, the power source potential line VDD, the node 19 connected to the input/output terminal I/O, and the ground potential line GND are electrically connected. Since electric current flows from the power source potential line VDD and the node 19 to the ground potential line GND, the surge voltage is suppressed.

The surge voltage generated transiently by the flow of the surge electric current through the primary protection circuit 4 is suppressed by the secondary protection circuit 8 placed near the internal circuit 2. The secondary protection circuit 8 is turned on in response to the trigger signal generated by the trigger circuit 12. Therefore, by the design of the trigger circuit 12, in comparison with the case of utilizing operation of the parasitic bipolar transistor, the voltage for starting the operation can be decreased. As a result, it becomes possible to increase the responsiveness to the surge voltage, and to protect the internal circuit 2 from electrostatic discharge more reliably.

When a negative electrostatic surge voltage is applied to the input/output terminal where a voltage at the GND terminal is taken as a reference voltage, the same effects can be obtained. In this case, electric current flows from the ground potential line GND to the input/output terminal I/O through the diode 14 of the primary protection circuit 4. The potential of the power source potential line GND is decreased temporarily. As a result, the trigger circuit 12 generates a trigger signal that is the same as in the case where the positive electrostatic surge voltage is generated as described above. In response to this trigger signal, all of the NMOS transistor 22 of the power source protection circuit 10, the NMOS transistor 18 and the PMOS transistor 20 of the secondary protection circuit 8 are turned on. By this operation, the same effect of protection against electrostatic discharge as in the case of the positive electrostatic surge voltage can be obtained.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A semiconductor device comprising an electrostatic discharge protection circuit, wherein the electrostatic discharge protection circuit comprises:
a power source system configured to supply a current to a semiconductor integrated circuit included in the semiconductor device through a power source potential line and a reference potential line;
a primary protection circuit configured to release a surge current to the power source system through a first node connected to a signal terminal when the surge current is generated at the signal terminal;
a trigger circuit configured to generate a trigger signal in response to a surge voltage generated at the power source system; and
a secondary protection circuit configured to release the surge current to the power source system through a second node connected between the first node and the semiconductor integrated circuit in response to the trigger signal.

2. The semiconductor device according to claim 1, further comprising:
a power source protection circuit configured to make conduction between the power supply potential line and the reference potential line in response to the trigger signal.

3. The semiconductor device according to claim 1, wherein the trigger circuit comprises:
a buffer circuit formed by at least one inverter element;
a first node configured to become high potential in response to the surge voltage being generated at the power source system; and
a second node configured to have a potential inverted to the first node by the first inverter element, and
the secondary protection circuit comprises a CMOS circuit,
a potential of the first node is supplied to a gate of an NMOS transistor included in the CMOS circuit, and
a potential of the second node is supplied to a gate of a PMOS transistor included in the CMOS circuit.

4. A method for protecting a semiconductor device from an electrostatic discharge, wherein the semiconductor device comprises a power source system configured to supply a current to a semiconductor integrated circuit included in the semiconductor device through a power source potential line and a reference potential line, and
the method comprises:
releasing a surge current to the power source system through a first node connected to a signal terminal when the surge current is generated at the signal terminal;
generating a trigger signal in response to a surge voltage generated at the power source system; and
releasing the surge current to the power source system through a second node connected between the first node and the semiconductor integrated circuit in response to the trigger signal.

5. The method for protecting a semiconductor device from the electrostatic discharge according to claim 4, further comprising:
making conduction between the power supply potential line and the reference potential line in response to the trigger signal.

6. The method for protecting a semiconductor device from the electrostatic discharge according to claim 4, wherein a trigger circuit configured to generate the trigger signal comprises:
a buffer circuit formed by at least one inverter element;
a first node configured to become high potential in response to the surge voltage being generated at the power source system; and
a second node configured to have a potential inverted to the first node by the first inverter element, and
the releasing the surge current to the power source system through the second node is performed by a CMOS circuit composed of an NMOS transistor connected between a reference potential line and the second node and a PMOS transistor connected between the second node and the power source potential line, and
the releasing the surge current to the power source system through the second node comprises:
supplying a potential of the first node to a gate of the NMOS transistor; and
supplying a potential of the second node to a gate of the PMOS transistor.
